(19) United States
(12) Patent Application Publication
(10) Pub. No.: US 2019/0184913 A1
(43) Pub. Date: Jun. 20, 2019

(54) RETENTION PUSH PIN FOR TEMPORARY MOUNTING IN VEHICLES

(71) Applicant: tesa SE, Norderstedt (DE)

(72) Inventor: Robert FALLON, New Hudson, MI (US)

(21) Appl. No.: 15/847,123

(22) Filed: Dec. 19, 2017

(51) Int. Cl. B60R 13/02; C08J 9/00; B62D 65/14; F16B 19/00

(52) U.S. Cl. CPC B60R 13/0206; C08J 9/00; C08J 2323/06; F16B 19/004; B62D 65/14

(57) ABSTRACT

Push pins and methods of use are provided. The push pin may be used for temporary mounting on a surface. The push pin may comprise a head, a pin tip adjacent to the head, and a rib protruding from the pin tip and disposed about the exterior profile of the pin tip; wherein the rib comprises a compressible material. The method comprises inserting the pin tip of the push pin into a film opening; wherein the pin tip of the push pin is inserted into the film opening past the rib of the push pin; and inserting the pin tip of the push pin into a surface opening; wherein the pin tip of the push pin is inserted into the surface opening past the rib of the push pin; wherein the head of the push pin is not inserted past the film opening or the surface opening.

### TECHNICAL FIELD

The present disclosure relates to the use of a push pin for mounting in a vehicle, and, more particularly, to a push pin configured to mount to the interior of a vehicle without adhesives or clamping.

### BACKGROUND

Vehicle interiors, specifically instrument panels, may need to be protected from physical and environmental damage during the manufacturing process or during repair. Protective films may be placed over portions of the interior to protect the underlying components. Due to the varying geometry of the vehicle interiors, the protective films may not remain in place without some retention mechanism to fix them in a desired position.

Adhesives may be used to fix the films in a desired position. The adhesives, for example, an adhesive tape, may be applied to the film and a surface of the vehicle interior to couple the two and hold the film in position on the surface. The adhesives may hold the film in place and prevent physical or environmental damage to the underlying vehicle interior. However, when the adhesive is removed it may leave behind a residue on the vehicle interior. The residue may be difficult or in some cases, impossible to remove without damaging the vehicle interior. Further, the adhesive removal may require cleaning equipment and/or cleaning chemicals that can add additional expense to the vehicle manufacturing or repair operation. Alternatively, even if an adhesive does not leave a residue it may still leave behind an imprint, sometimes referred to as “ghosting” in the art, in which the outline of the adhesive is still visible on the interior surface even after removal.

Instead of adhesives, mechanical mechanisms, such as clamps, may be used to fix the film in a desired position. The clamps, for example, alligator clips, may retain the film in place by clamping a portion of the film to a structure on the interior of the vehicle such as an air conditioning vent. However, as the clamp applies pressure to the interior structure it may also risk damaging the interior structure. Further, the clamp can leave an indentation or notches in the surface of the interior structure if too much pressure is applied. Moreover, the clamp itself may break resulting in added expense to the vehicle manufacturing or repair operation.

Accordingly, there is a need for a mounting mechanism that does not require the use of adhesives or clamps and may be used on the interior surfaces of vehicles.

### SUMMARY

In an embodiment, a push pin provided. The push pin may be used for temporary mounting on a surface, the push pin may comprise a head, a pin tip adjacent to the head, and a rib protruding from the pin tip and disposed about the exterior profile of the pin tip; wherein the rib comprises a compressible material.

Additionally or alternatively, the push pin may include one or more of the following features individually or in combination. The push pin may be one continuous piece comprising the same compressible material of the rib. The head, the pin tip, and the rib may be discrete components and the push pin comprises these assembled discrete components of the head, the pin tip, and the rib. The head may further comprise an adhesive. The pin tip and the rib may not comprise adhesives or clamping means. The push pin may further comprise a multiple of ribs. The compressible material may comprise a compressible material selected from the group consisting of polyethylene foam, polypropylene foam, polychloroprene foam, polyimide foam, polystyrene foam, polyurethane foam, polyvinylchloride foam, silicone foam, styrene-butadiene-styrene block copolymer rubber, styrene-butadiene rubber, natural polyisoprene, synthetic polyisoprene, polybutadiene rubber, chloroprene rubber, butyl rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, and any combination thereof. The head may comprise a first head and the push pin may further comprise a second head that is interchangeable with the first head. The rib may comprise a first rib and the push pin may further comprise a second rib that is interchangeable with the first rib.

In an embodiment, a method of covering a surface of an interior of a vehicle is provided. The method may comprise providing a push pin comprising: a head, a pin tip adjacent to the head, and a rib protruding from the pin tip and disposed about the exterior profile of the pin tip; wherein the rib comprises a compressible material. The method may further comprise inserting the pin tip of the push pin into a film opening; wherein the pin tip of the push pin is inserted into the film opening past the rib of the push pin; and inserting the pin tip of the push pin into a surface opening; wherein the pin tip of the push pin is inserted into the surface opening past the rib of the push pin; wherein the head of the push pin is not inserted past the film opening or the surface opening.

Additionally or alternatively, the method may include one or more of the following features individually or in combination. The method may further comprise repeating the method with a different push pin, a different surface opening, and a different film opening. The surface opening may be an air conditioning vent. The surface may comprise an instrument panel of a vehicle. The push pin may be one continuous piece comprising the same compressible material of the rib. The head, the pin tip, and the rib may be discrete components and the push pin comprises these assembled discrete components of the head, the pin tip, and the rib. The head may further comprise an adhesive. The pin tip and the rib may not comprise adhesives or clamping means. The push pin may further comprise a multiple of ribs. The compressible material may comprise a compressible material selected from the group consisting of polyethylene foam, polypropylene foam, polychloroprene foam, polyimide foam, polystyrene foam, polyurethane foam, polyvinylchloride foam, silicone foam, styrene-butadiene-styrene block copolymer rubber, styrene-butadiene rubber, natural polyisoprene, synthetic polyisoprene, polybutadiene rubber, chloroprene rubber, butyl rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, and any combination thereof. The head may comprise a first head and the push pin may further comprise a second head that is interchangeable with the first head. The rib may comprise a first rib and the push pin may further comprise a second rib that is interchangeable with the first rib.

In an embodiment, a push pin provided. The push pin may be used for temporary mounting on a surface, the push pin may comprise a holster, a pin tip adjacent to the holster, and a rib protruding from the pin tip and disposed about the exterior profile of the pin tip; wherein the rib comprises a compressible material.

Additionally or alternatively, the method may include one or more of the following features individually or in combination. The holster may be used to hold an accessory selected from the group consisting of cell phones, music players, music storage systems, air fresheners, GPS systems, lights, trash containers, storage containers, fans, and any combination thereof. The push pin may be one continuous piece comprising the same compressible material of the rib. The holster, the pin tip, and the rib may be discrete components and the push pin comprises these assembled discrete components of the holster, the pin tip, and the rib. The pin tip and the rib may not comprise adhesives or clamping means. The push pin may further comprise a multiple of ribs. The compressible material may comprise a compressible material selected from the group consisting of polyethylene foam, polypropylene foam, polychloroprene foam, polyimide foam, polystyrene foam, polyurethane foam, polyvinylchloride foam, silicone foam, styrene-butadiene-styrene block copolymer rubber, styrene-butadiene rubber, natural polyisoprene, synthetic polyisoprene, polybutadiene rubber, chloroprene rubber, butyl rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, and any combination thereof. The holster may comprise a first holster and the push pin may further comprise a second holster that is interchangeable with the first holster. The rib may comprise a first rib and the push pin may further comprise a second rib that is interchangeable with the first rib.

### BRIEF DESCRIPTION OF THE DRAWINGS

Illustrative examples of the present disclosure are described in detail below with reference to the attached drawing figures, which are incorporated by reference herein, and wherein:

FIG. 1 is an isometric illustration of an example of a push pin in accordance with certain embodiments of the present disclosure;

FIG. 2 illustrates a cross-section of the example push pin of FIG. 1 as used to retain a film on a surface of a vehicle interior in accordance with the examples disclosed herein;

FIG. 3 is a photograph of an example push pin in accordance with certain embodiments of the present disclosure;

FIG. 4 is a photograph of multiple example push pins used to retain a film on a surface of a vehicle interior in accordance with certain embodiments of the present disclosure;

FIG. 5 illustrates an isometric view of another example of a push pin in accordance with certain embodiments of the present disclosure;

FIG. 6 illustrates a cross-sectional view of an additional example of a push pin in accordance with certain embodiments of the present disclosure; and

FIG. 7 illustrates an isometric view of yet another example of a push pin in accordance with certain embodiments of the present disclosure.

The illustrated figures are only exemplary and are not intended to assert or imply any limitation with regard to the environment, architecture, design, or process in which different examples may be implemented.

### DETAILED DESCRIPTION

The present disclosure relates to the use of a push pin for mounting in a vehicle, and, more particularly, to a push pin configured to mount to the interior of a vehicle without adhesives or clamping.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

The embodiments described herein comprise the use of a push pin. The push pin may be mounted to an interior surface of a vehicle. In some embodiments the push pin may retain a film over the interior surface. In some alternative embodiments, the push pin may function as an accessory mount allowing for the holstering of vehicle and/or personal accessories on the interior of a vehicle. The push pin may mount to the interior of the vehicle without the use of an adhesive or a clamp. The term “clamp,” as used herein, generally refers to any clamp, clip, clasp, brace, vice, press or other similar such device. Although some examples may describe the use of the push pin for the interior of a vehicle, it is to be understood that the push pin may be used to mount to any opening in any surface in which the push pin may be inserted. As such, this disclosure explicitly contemplates the use of the push pin to retain, mount, or hold any object in any surface into which the push pin may be inserted.

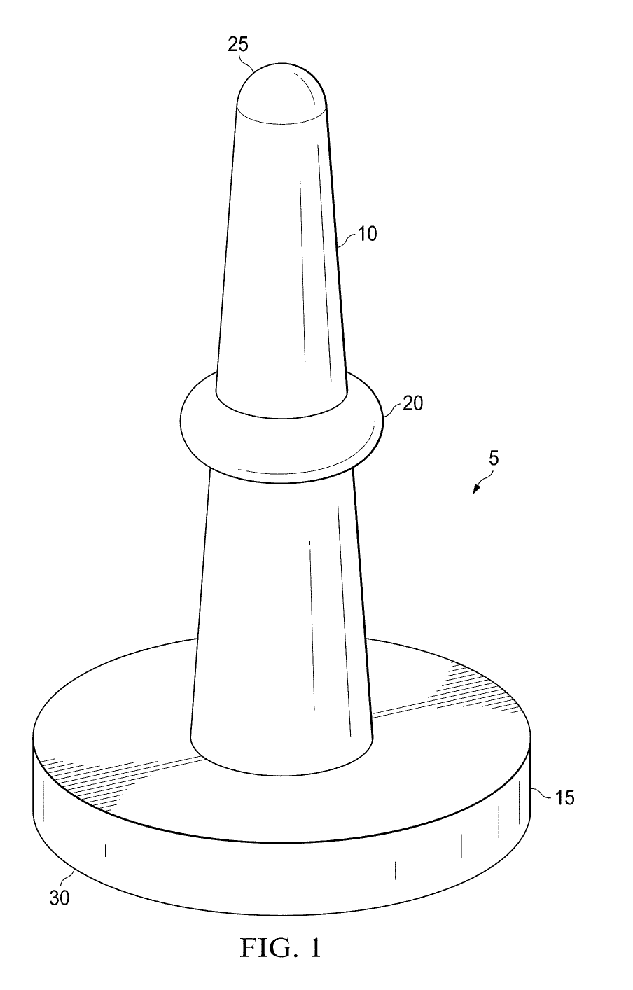

FIG. 1 is an isometric illustration of a push pin, generally 5. Push pin 5 comprises pin tip 10, a head 15, and at least one rib 20. In some examples, at least a portion of pin tip 10 may be pointed and have a sharpened or generally tapered tip at the terminal end 25 farthest from the head 15. In other examples, no portion of pin tip 10 may be pointed, and the pin tip 10 may comprise an elongated rod narrower than head 15 in diameter. Rib 20 is a ring-like circular protrusion projecting around the profile of the pin tip 10. Rib 20 may be any shape (e.g., rib 20 may be ovoid having rounded edges). In the illustrated example, only one rib 20 is illustrated However, it is to be understood that push pin 5 may comprise any multiple of rib 20 as desired. Head 15 is illustrated as a planar circular shape on the opposing terminal end 30 from terminal end 25. Head 15 may be any shape including, but not limited to, square, triangular, etc.

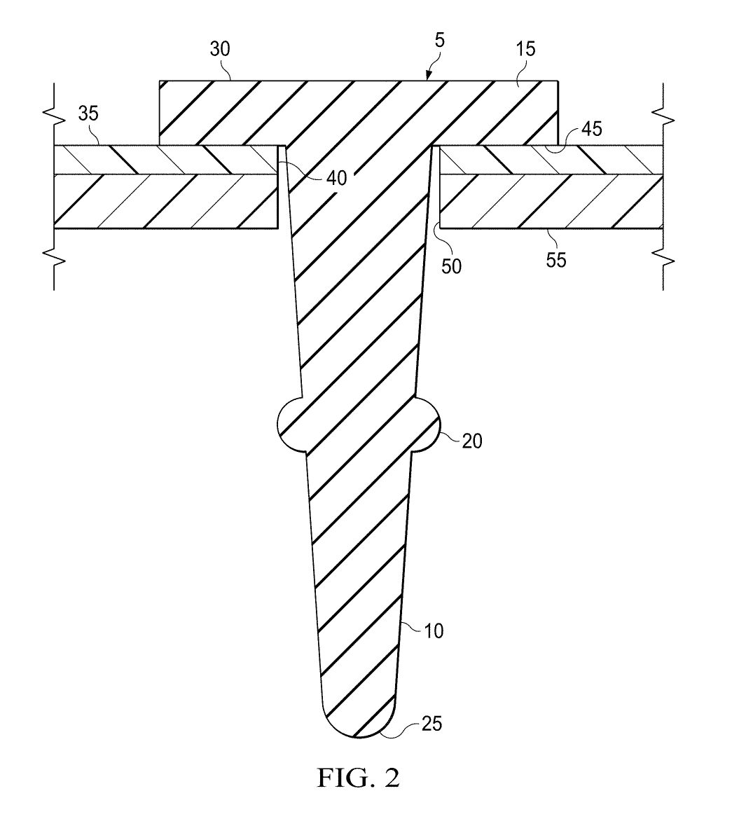

FIG. 2 illustrates a cross-section of push pin 5 (as discussed above and illustrated in FIG. 1) when used to retain a film 35 on a surface 55 of a vehicle interior. When desired for use, pin tip 10 of push pin 5 may be inserted into an opening 40 made within film 35. The pin tip 10 may be inserted into the opening 40 past the portion of pin tip 10 comprising the one or more ribs 20 such that the rib 20 is inserted into and through the opening 40. In the illustrated example, push pin 5 is inserted into opening 40 to a sufficient depth that film 35 contacts the underside 45 of head 15. Head 15 has a diameter greater than that of the diameter of opening 40 and prevents film 35 from sliding or being pulled past head 15. Push pin 5 may then be inserted into an opening 50 in a surface 55 of a vehicle interior. The pin tip 10 may be inserted into the opening 50 past the portion of pin tip 10 comprising the one or more ribs 20 such that the rib 20 is inserted into and through the opening 50. In the illustrated example, push pin 5 is inserted into opening 50 to a sufficient depth that the film 35 contacts the surface 55. The opening 50 may be any opening in a surface 55 of a vehicle and is not limited to openings in the vehicle interior. An example of an opening 50 is an air conditioning vent. The push pin 5 is sized such that the pin tip 10 may easily pass through the opening 50, but that the head 15 is too large in diameter to pass through opening 50. The rib 20 is of a sufficiently small enough size to pass through the opening 50 when sufficient pressure is applied to the rib 20 to compress the rib 20 to a size sufficient to pass through the opening 50. Conversely, the rib 20 is also sized sufficiently large enough to prevent passage of the push pin 5 out of the opening 50 and/or the opening 40 without application of a force sufficient to pull push pin 5 free by compression of the rib 20. This process may be repeated with additional push pins if necessary to fix the film 35 into a desired position over the surface 55 of the vehicle interior.

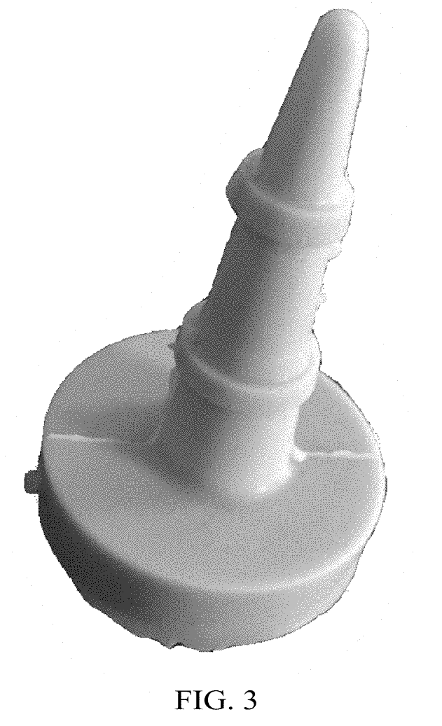

FIG. 3 is a photograph of an example push pin. The example push pin is similar to the push pin 5 illustrated in FIGS. 1 and 2 except that the example push pin comprises two ribs spaced apart from each other along the profile of the pin tip. This example push pin was molded as one piece from a compressible styrene-butadiene rubber. As discussed above, the push pins described herein may comprise any multiple of ribs of any size and shape. The ribs may be spaced apart on the pin tip as desired.

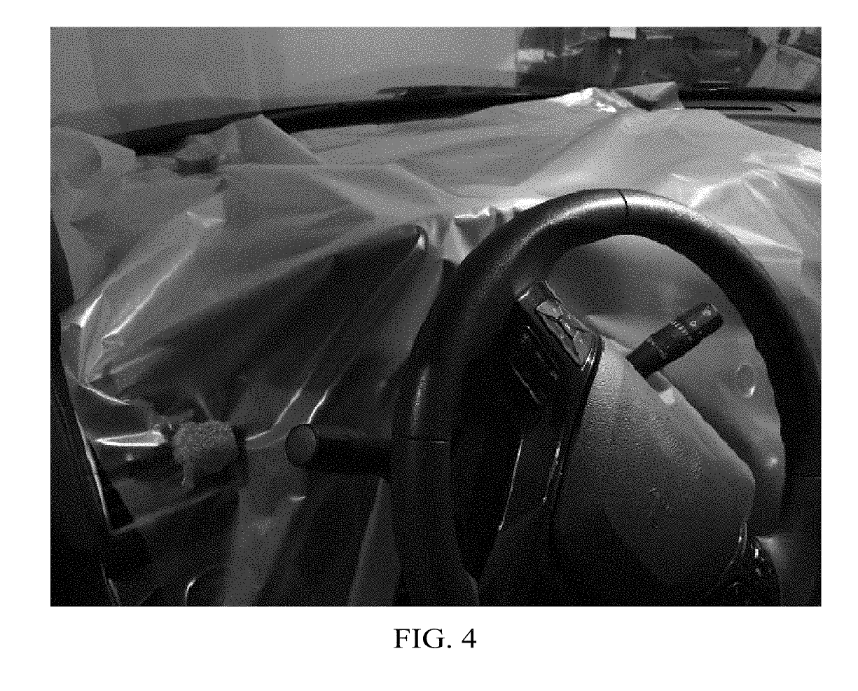

FIG. 4 is a photograph of multiple example push pins used to hold a film on top of a surface of the interior of a vehicle. As described in FIG. 2, the push pins have been inserted through openings in the film and then into openings within the surface of the interior of the vehicle. In this specific photograph, the openings are the air conditioning vents of the interior of the vehicle. The push pin ribs are compressible and are able to slide into the air conditioning vents with sufficient applied force. The push pin is then able to hold the film into a desired position as illustrated in the photograph. The push pins may be removed if a sufficient force is applied by pulling the head or other graspable portion of the push pin to compress the ribs to a degree that the push pin is able to be pulled out of the air conditioning vent. The push pin illustrated by the photograph of FIG. 4 was machined from a piece of compressible polyethylene foam.

The push pin may be made from any compressible material. General examples of compressible materials include, but are not limited to, elastomeric materials, foamed materials, and the like. Specific examples of materials include polyethylene foam, polypropylene foam, polychloroprene foam, polyimide foam, polystyrene foam, polyurethane foam, polyvinylchloride foam, silicone foam, styrene-butadiene-styrene block copolymer (hereafter “SBS”) rubber, styrene-butadiene rubber (hereafter “SBR”), natural polyisoprene, synthetic polyisoprene, polybutadiene rubber, chloroprene rubber, butyl rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, or any combination thereof. In some alternative examples where the push pin is comprised of discrete components assembled to collectively form the push pin, all of the discrete components may be made from the same or different compressible materials, or only the rib(s) of the push pin may be made of compressible materials. If only the rib(s) of the push pin comprise compressible materials, the remaining materials (e.g., the head, the pin tip, or the holster discussed below) may be made from non-compressible materials such as hard plastics, metals, wood, composites thereof, or any combination thereof.

The push pin may be molded, machined, or otherwise provided as one continuous piece. For example, the push pin of FIG. 3 was injection molded, and the flash from the molding process is still visible on the underside of the head. As another example, the push pins of FIG. 4 were machined from a piece of foam into the desired shape of the push pin. The push pin may be manufactured by any sufficient process, and one of ordinary skill in the art, with the benefit of this disclosure, will be able to manufacture a push pin as described herein. In alternative embodiments, the push pin may not comprise one piece and may be assembled from separate components that collectively comprise the push pin. These discrete components may be molded, machined, or otherwise provided from any suitable manufacturing process. Assembly of the discrete components may involve coupling the components together via threaded connections, adhesives, latches, or any other such means as would be readily apparent to one of ordinary skill in the art. The discrete components may be interchangeable and capable of being switched with alternative components. Alternatively, the discrete components may be permanently attached to one another precluding separation of the individual components of the push pin.

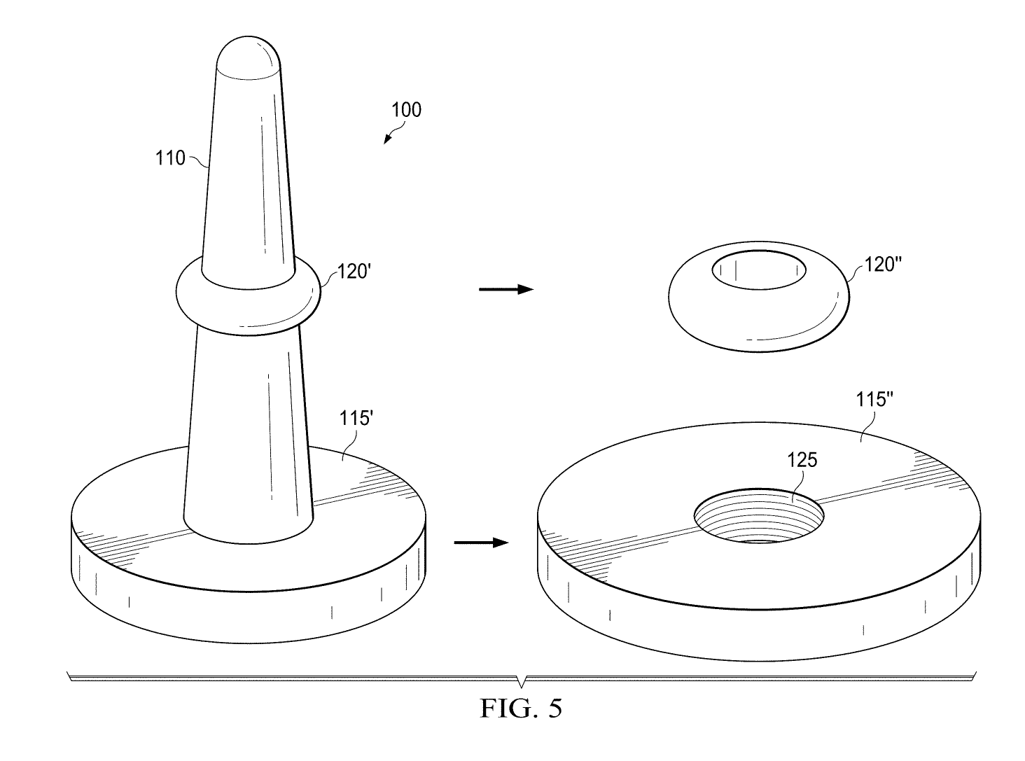

FIG. 5 illustrates an isometric view of another embodiment of a push pin. Push pin 100 comprises interchangeable components. Push pin 100 comprises a pin tip 110. The pin tip 110 is a separate component from the head 115′ and rib 120′. If a different head is preferred head 115′ may be uncoupled from pin tip 110, and then head 115″ may be coupled to pin tip 110. For example, if a different size or shaped head is preferred, the head may be exchanged with one better suited for a particular application. The heads 115′ and 115″ comprise a commonly-sized coupling connection 125 (e.g., a commonly-sized threaded connection) that fits each head 115′ and 115″. The use of a commonly-sized coupling connection 125 allows for multiple heads of different sizes, shapes, and materials to interchange with a shared pin tip 110. Further, it allows for a quick and easy exchange of one head for another without the need to adapt the coupling connection. Similarly, the rib 120′ may be interchanged with the rib 120″. The interior diameters of rib 120′ and rib 120″ are sized the same which allows for multiple ribs to fit over the pin tip 110 and be interchanged with a shared pin tip 110. The ribs may vary in outer diameter, outer shape, or outer materials and may comprise any type of coupling connection (e.g., a threaded connection) that may couple the ribs to the pin tip 110. The coupling connection materials may comprise different materials than the rest of the pin tip 110, heads 115′ and 115″, or ribs 120′ and 120″. For example, the coupling connection materials may be metal or other such materials embedded in or otherwise attached to the compressible materials forming the push pin 100 and its individual components.

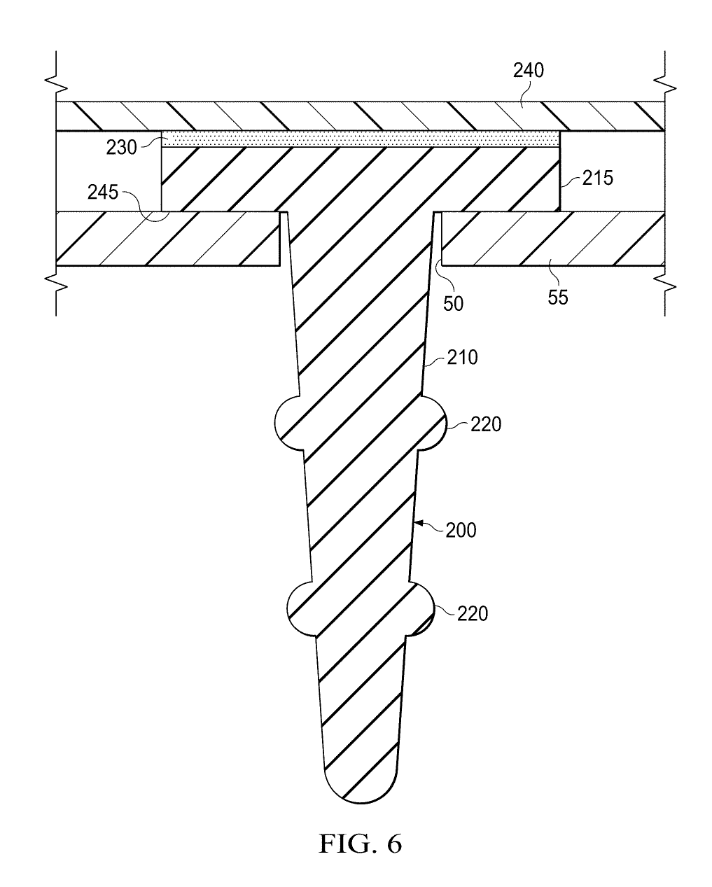

FIG. 6 illustrates a cross-sectional view of another embodiment of a push pin. The push pin 200 is similar to the push pin 5 illustrated in FIGS. 1 and 2. The push pin 200 comprises a pin tip 210, a head 215, and ribs 220. Push pin 200 additionally comprises an adhesive layer 230 adjacent to the head 215 and layered upon the head 215. Adhesive layer 230 may cover all of or just a portion of the head 215. The adhesive layer 230 may be used to adhere a material to the push pin 200. In the illustrated example, push pin 200 is used to adhere a film 240 to the push pin 200. When desired for use, the push pin 200 may be inserted into an opening 50 in a surface 55 of a vehicle interior. The pin tip 210 may be inserted into the opening 50 past the portion of pin tip 210 comprising one or more ribs 220 such that the ribs 220 are inserted into and through the opening 50. In the illustrated example, the push pin 200 is inserted into the opening 50 to a sufficient depth that the underside 245 of head 215 contacts the surface 55. The opening 50 may be any opening in a surface 55 of a vehicle and is not limited to openings in the vehicle interior. An example of an opening 50 is an air conditioning vent. The push pin 200 is sized such that the pin tip 210 may easily pass through the opening 50, but the head 215 is too large in diameter to pass through the opening 50. Ribs 220 are of a sufficiently small enough size to pass through the opening 50 when sufficient pressure is applied to pin tip 210 to compress the ribs 220. Conversely, the ribs 220 are of a sufficiently large enough size to prevent passage of the push pin 200 out of the opening 50 without application of a force sufficient to pull the push pin 200 free by compressing the ribs 220. A film 240 may then contact adhesive layer 230 to position film 240 on the interior of the vehicle as desired. In some embodiments, a liner or other covering may be placed on adhesive layer 230 to prevent premature contact with adhesive layer 230. The liner may be removed prior to use.

The adhesive in the adhesive layer 230 may be any adhesive sufficient for a desired use. Examples may include, but are not limited to, waterborne adhesives, solventborne adhesives, hot melt adhesives, acrylic adhesives, natural and/or synthetic rubber adhesives, silicone adhesives, or any combination thereof. It is to be understood that the adhesive should be chosen such that it does not negatively interfere with the compressible material used to form push pin 200 or the material of the component to which the adhesive layer 230 is to attach the push pin 200. The push pin 200 may be used in embodiments where it may be more desirable to adhere a material to the push pin 200 instead of pushing the push pin 200 through a hole or opening in the material. However, push pin 200 is still mountable inside the vehicle interior without the use of adhesives or clamping, and the pin tip 210 and ribs 220 portions of the push pin 200 do not comprise adhesives or clamping means. The adhesive layer 230 is used only to adhere a material to the mounted push pin 200. If not already mounted to a surface, the push pin 200 may then be mounted to the surface.

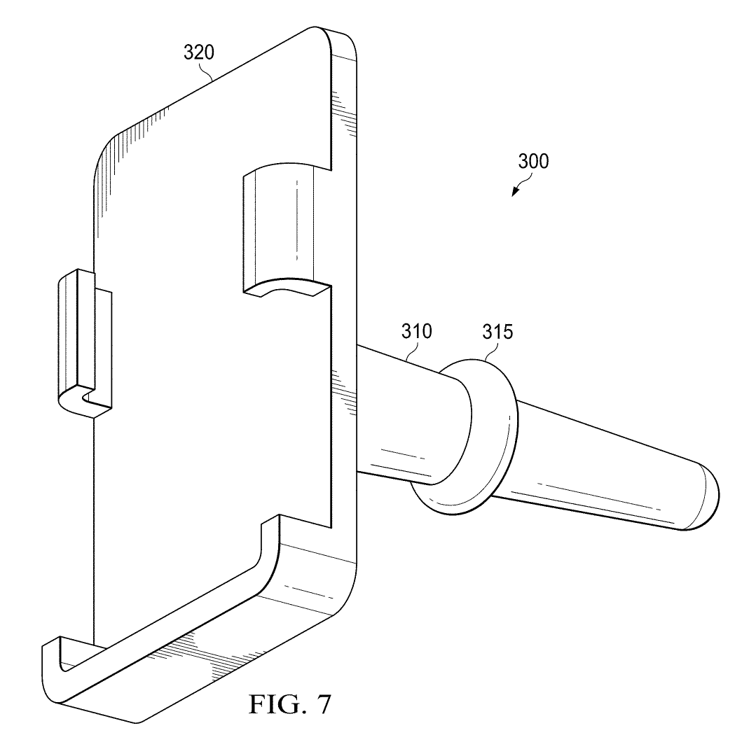

FIG. 7 illustrates an isometric view of another embodiment of a push pin. Push pin 300 comprises a pin tip 310 and at least one rib 315; however, the head has been replaced with a holster 320. Holster 320 may be used to hold accessories. Examples of accessories may include, but are not limited to, cell phones, music players/storage systems, air fresheners, GPS systems, lights, trash/storage containers, fans, and the like. Push pin 300 functions identically to the other push pin embodiments described herein and may be inserted into any opening in a surface of a vehicle interior. A chosen accessory may then be placed in the holster 320. Holster 320 may be designed having any sufficient shape for holding a desired accessory. Push pin 300 may comprise holster 320 together with pin tip 310 and at least one rib 315 as one continuous piece; alternatively, push pin 300 may comprise separate components which collectively provide push pin 300. For example, push pin 300 may comprise a holster 320 that is interchangeable with other holsters 320 having different sizes and/or shapes. The interchangeable holsters 320 may have a commonly-sized coupling connection allowing the interchangeable holsters 320 to share a pin tip 310. The holsters 320 may be switched as desired to hold different accessories.

In all embodiments, the push pin may be removed by applying a sufficient force to the head or holster to compress the at least one rib such that the rib may slide out of any opening in a surface in which the push pin was inserted.

One or more illustrative examples incorporating the examples disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations can be made herein without departing from the spirit and scope of the disclosure as defined by the following claims.

What is claimed is:

1. A push pin for temporary mounting on a surface, the push pin comprising:
a head,
a pin tip adjacent to the head, and
a rib protruding from the pin tip and disposed about the exterior profile of the pin tip; wherein the rib comprises a compressible material.

2. The push pin of claim 1, wherein the push pin is one continuous piece comprising the same compressible material of the rib.

3. The push pin of claim 1, wherein the head, the pin tip, and the rib are discrete components and wherein the push pin comprises the assembled discrete components of the head, the pin tip, and the rib.

4. The push pin of claim 1, wherein the head further comprises an adhesive.

5. The push pin of claim 1, wherein the pin tip and the rib do not comprise adhesives or clamping means.

6. The push pin of claim 1, wherein the push pin further comprises a multiple of ribs.

7. The push pin of claim 1, wherein the compressible material comprises a compressible material selected from the group consisting of polyethylene foam, polypropylene foam, polychloroprene foam, polyimide foam, polystyrene foam, polyurethane foam, polyvinylchloride foam, silicone foam, styrene-butadiene-styrene block copolymer rubber, styrene-butadiene rubber, natural polyisoprene, synthetic polyisoprene, polybutadiene rubber, chloroprene rubber, butyl rubber, nitrile rubber, ethylene propylene rubber, ethylene propylene diene rubber, epichlorohydrin rubber, polyacrylic rubber, silicone rubber, fluorosilicone rubber, fluoroelastomers, perfluoroelastomers, polyether block amides, chlorosulfonated polyethylene, ethylene-vinyl acetate, and any combination thereof.

8. The push pin of claim 1, wherein the head is a first head and wherein the push pin further comprises a second head that is interchangeable with the first head.

9. The push pin of claim 1, wherein the rib is a first rib and wherein the push pin further comprises a second rib that is interchangeable with the first rib.

10. A method of covering a surface on an interior of a vehicle, the method comprising:
providing a push pin comprising:
a head,
a pin tip adjacent to the head, and
a rib protruding from the pin tip and disposed about the exterior profile of the pin tip; wherein the rib comprises a compressible material;
inserting the pin tip of the push pin into a film opening; wherein the pin tip of the push pin is inserted into the film opening past the rib of the push pin; and
inserting the pin tip of the push pin into a surface opening; wherein the pin tip of the push pin is inserted into the surface opening past the rib of the push pin;
wherein the head of the push pin is not inserted past the film opening or the surface opening.

11. The method of claim 10, further comprising repeating the method with a different push pin, a different surface opening, and a different film opening.

12. The method of claim 10, wherein the surface opening is an air conditioning vent.

13. The method of claim 10, wherein the surface comprises an instrument panel of a vehicle.

14. The method of claim 10, wherein the push pin is one continuous piece comprising the same compressible material of the rib.

15. The method of claim 10, wherein the head, the pin tip, and the rib are discrete components and wherein the push pin comprises the assembled discrete components of the head, the pin tip, and the rib.

16. The method of claim 10, wherein the pin tip and the rib do not comprise adhesives or clamping means.

17. A push pin for temporary mounting on a surface, the push pin comprising:
a holster,
a pin tip adjacent to the holster, and
a rib protruding from the pin tip and disposed about the exterior profile of the pin tip; wherein the rib comprises a compressible material.

18. The push pin of claim 17, wherein the holster is used to hold an accessory selected from the group consisting of cell phones, music players, music storage systems, air fresheners, GPS systems, lights, trash containers, storage containers, fans, and any combination thereof.

19. The push pin of claim 17, wherein the push pin is one continuous piece comprising the same compressible material of the rib.

20. The push pin of claim 17, wherein the push pin comprises the assembled discrete components of the holster, the pin tip, and the rib.
